(19) United States
(12) Patent Application Publication
(10) Pub. No.: US 2012/0306270 A1
(43) Pub. Date: Dec. 6, 2012

(54) ENERGY MANAGEMENT APPARATUS AND ENERGY MANAGEMENT METHOD, AND ENERGY MANAGEMENT SYSTEM INCLUDING ENERGY MANAGEMENT APPARATUS

(75) Inventors: Jung Hwan OH, Seoul (KR); Jae Seong PARK, Daejeon (KR); Dong Min SON, Suwon-si (KR)

(73) Assignee: LSIS CO., LTD., Anyang (KR)

(21) Appl. No.: 13/407,661

(22) Filed: Feb. 28, 2012

(30) Foreign Application Priority Data
May 31, 2011 (KR) 10-2011-0052081

(51) Int. Cl. H02J 9/00

(52) U.S. Cl. 307/23

(57) ABSTRACT

The present disclosure relates to an energy management apparatus, an energy management method and an energy management system including an energy management apparatus, in which a new renewable energy generation system such as a charged energy of a battery in an electric vehicle, a solar energy generation system, a wind power energy generation system or a fuel cell system determines whether an emergency energy is supplied, in case a main energy is not supplied due to reasons such as blackout, the emergency energy is supplied to energy using equipment if the emergency energy is supplied, the energy using equipment to be supplied with the emergency energy is pre-set, and the emergency energy is supplied only to the pre-set energy using equipment.

### CROSS REFERENCE TO RELATED APPLICATIONS

Pursuant to 35 U.S.C.§119 (a), this application claims the benefit of earlier filing date and right of priority to Korean Patent Application No.10-2011-0052081, filed on May 31, 2011, the contents of which are hereby incorporated by reference in their entirety.

### BACKGROUND OF THE DISCLOSURE

1. Field

The present disclosure relates to an energy management apparatus, an energy management method and an energy management system including an energy management apparatus, and more particularly to an energy management apparatus and an energy management method configured to use an energy supplied by a new renewable energy generation system such as a charged energy of a battery in an electric vehicle, a solar energy generation system, a wind power energy generation system or a fuel cell system as an emergency energy in case a main energy is not supplied due to reasons such as blackout, and to supply the energy to a predetermined energy using equipment, and to an energy management system including an energy management apparatus for management of energy supply.

2. Background

Various types of energy using equipment such as a light device, a refrigerator and a washing machine are very useful and make our life comfortable. The energy using equipment is operated by energy such as a commercial Alternating Current (AC) power, and if the energy is not supplied, the equipment cannot perform a given function. That is, a factory that needs continuous energy supply cannot operate if the energy is not supplied, and even a home apparently becomes subject to inconveniences if the energy is not supplied.

A large factory may be equipped with own energy generating facilities whereby energy generated by the own energy generating facilities can be supplied to keep operating the factory even if no energy is supplied from outside. However, the energy generating facilities need lots of installation costs such that it is not easy for a home to equip the energy generating facilities.

Therefore, a number of techniques and researches have been devised and waged to use energy charged in a battery of an electric vehicle, in case energy is not supplied to a home from outside. Furthermore, researches have been also made to supply energy to apartment houses generated by a new renewable energy generating system such as a charged energy of a battery in an electric vehicle, a solar energy generation system, a wind power energy generation system or a fuel cell system as an emergency energy through installation of such new renewable energy generation system.

### SUMMARY

The present disclosure has been proposed to solve the foregoing need, and an object of certain embodiments of the present disclosure is to provide an energy management apparatus and an energy management method configured to supply an energy supplied by an emergency energy supply source to an energy using equipment, in case a main energy is not supplied from outside, and an energy management system including an energy management apparatus.

It is another object of certain embodiments of the present disclosure to provide to provide an energy management apparatus and an energy management method configured to supply an emergency energy to only a predetermined particular energy using equipment out of a plurality of energy using equipment, in case the emergency energy supplied by an emergency energy supply source is supplied to the plurality of energy using equipment, whereby the emergency energy can be effectively used, and an energy management system including an energy management apparatus.

Additional advantages, objects, and features of the present disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purposes of the disclosure, as embodied and broadly described herein, and according to the energy management apparatus and an energy management method, and the energy management system including an energy management apparatus, the apparatus includes a main energy supply determining unit determining whether an energy is supplied from a main supply unit, and an emergency energy supply determining unit whether an emergency energy is supplied from an emergency energy supply unit.

In a case the main energy supply determining unit determines that the energy is supplied from the main energy supply unit, a smart meter is controlled to select the main energy, and the smart meter supplies the selected main energy to a plurality of energy using equipment.

In a case the main energy supply determining unit determines that the energy is not supplied from the main energy supply unit, and that the emergency energy supply determining unit determines that the emergency energy is supplied from the emergency energy supply unit, the smart meter is controlled to select the emergency energy and the smart meter supplies the selected emergency energy to a plurality of energy using equipment.

At this time, due to limit in the amount of energy supplied by an emergency energy supply source, a plurality of energy using equipment to receive the emergency energy is pre-set, and the emergency energy is supplied only to the pre-set energy using equipment, in a case the main energy is not supplied to enable an efficient use of the emergency energy.

In one general aspect of the present disclosure, there is provided an energy management apparatus, the apparatus comprising: a main energy supply determining unit determining whether main energy is supplied from a main energy supply unit; and an emergency energy supply determining unit determining whether emergency energy is supplied from an emergency energy supply source, and a smart meter supplying the main energy to the plurality of energy using equipment, in a case the main energy supply determining unit determining that energy is supplied from the main energy supply unit, and selecting the emergency energy to supply the emergency energy to the plurality of energy using equipment, in a case the main energy supply determining unit determines that the main energy is not supplied from the main energy supply unit, and that the emergency energy supply determining unit determines that the emergency energy is supplied from the emergency energy supply source.

Preferably, the apparatus further includes an energy selection switch for switching the main energy and emergency energy to select one of the main energy and emergency energy, wherein the smart meter allows the energy selection switch to select the main energy and to controllably supply the main energy to the plurality of energy using equipment, in a case the main energy supply determining unit determines that the main energy is supplied, and the smart meter allows the energy selection switch to select the emergency energy and to controllably supply the emergency energy to the plurality of energy using equipment, in a case the main energy supply determining unit determines that the main energy is not supplied and the emergency energy supply determining unit determines that the emergency energy is being supplied.

Preferably, the emergency energy supply source supplies a charged energy of a battery mounted at an electric vehicle by converting the charged energy to a commercial energy.

Preferably, the emergency energy supply source includes energy generated by a solar energy generation system, a wind power generation system, or a fuel cell system.

Preferably, the emergency energy supply determining unit determines that the emergency energy has not been supplied if the emergency energy supplied by the emergency energy supply source is less than a preset amount of energy.

Preferably, the smart meter includes an energy supply controller allowing the energy selection switch to controllably select the main energy, in a case the main energy supply determining unit determines that main energy is supplied from the main energy supply unit, and allowing the energy selection switch to controllably select the emergency energy, in a case the main energy supply determining unit determines that the main energy is not supplied from the main energy supply unit, and that the emergency energy supply determining unit determines that the emergency energy is supplied from the emergency energy supply source; and an energy usage amount detecting unit supplying the energy selected by the selection switch to the plurality of energy using equipment in response to control of the energy supply controller and detecting an energy usage amount.

Preferably, the energy supply controller controls in such a manner that the energy selection switch controllably supplies the emergency energy only to the preset plurality of energy using equipment among the plurality of energy using equipment, in a case the energy selection switch controllably selects the emergency energy.

Preferably, the pre-set energy using equipment includes an illumination load.

Preferably, the smart meter further includes a memory for storing lists of the preset energy using equipment.

In another general aspect of the present disclosure, there is provided an energy management system including an energy management apparatus, the system comprising: a plurality of energy using equipment; a plurality of energy supply switches supplying energy to each of the plurality of energy using equipment; and an energy management apparatus selecting one energy by determining whether main energy and emergency energy are supplied, and supplying one of the selected energies to the plurality of energy using equipment through the plurality of energy supply switches.

Preferably, the energy management apparatus includes: a main energy supply determining unit determining whether main energy is supplied; an emergency energy supply determining unit determining whether emergency energy is supplied from an emergency energy supply unit; an energy selection switch switching the main energy and the emergency energy and selecting one of the main energy and the emergency energy; and a smart meter allowing the energy selection switch to select the main energy and the main energy to be controllably supplied to the plurality of energy using equipment in a case the main energy supply determining unit determines that the main energy is supplied, and allowing the emergency energy selection switch to select the emergency energy and the emergency energy to be controllably supplied to the plurality of energy using equipment in a case the main energy supply determining unit determines that the energy is not supplied, and that the emergency energy supply determining unit determines that the emergency energy is supplied.

Preferably, the energy management apparatus includes: a main energy supply determining unit determining whether main energy is supplied from a main energy supply unit; and an emergency energy supply determining unit determining whether emergency energy is supplied from an emergency energy supply source, and a smart meter supplying the main energy to the plurality of energy using equipment, in a case the main energy supply determining unit determining that energy is supplied from the main energy supply unit, and selecting the emergency energy to supply the emergency energy to the plurality of energy using equipment, in a case the main energy supply determining unit determines that the main energy is not supplied from the main energy supply unit, and that the emergency energy supply determining unit determines that the emergency energy is supplied from the emergency energy supply source.

Preferably, the emergency energy supply source supplies a charged energy of a battery mounted at an electric vehicle by converting the charged energy to a commercial energy.

Preferably, the emergency energy supply source includes energy generated by a solar energy generation system, a wind power generation system, or a fuel cell system.

Preferably, the emergency energy supply determining unit determines that the emergency energy has not been supplied if the emergency energy supplied by the emergency energy supply source is less than a preset amount of energy.

Preferably, the smart meter includes an energy supply controller allowing the energy selection switch to controllably select the main energy, in a case the main energy supply determining unit determines that main energy is supplied from the main energy supply unit, and allowing the energy selection switch to controllably select the emergency energy, in a case the main energy supply determining unit determines that the main energy is not supplied from the main energy supply unit, and that the emergency energy supply determining unit determines that the emergency energy is supplied from the emergency energy supply source; and an energy usage amount detecting unit supplying the energy selected by the selection switch to the plurality of energy using equipment in response to control of the energy supply controller and detecting an energy usage amount.

Preferably, the smart meter includes: an energy selection switch selecting the main energy or the emergency energy; an energy supply controller allowing the energy selection switch to controllably select the main energy, in a case the main energy supply determining unit determines that main energy is supplied from the main energy supply unit, and allowing the energy selection switch to controllably select the emergency energy, in a case the main energy supply determining unit determines that the main energy is not supplied from the main energy supply unit, and that the emergency energy supply determining unit determines that the emergency energy is supplied from the emergency energy supply source; and an energy usage amount detecting unit supplying the energy selected by the selection switch to the plurality of energy using equipment in response to control of the energy supply controller and detecting an energy usage amount.

In still another general aspect of the present disclosure, there is provided an energy management method, the method comprising: determining, by a main energy supply determining unit, whether main energy is supplied; determining, by an emergency energy supply determining unit, whether emergency energy is supplied; and controllably supplying, by an energy supply controller, the emergency energy to a plurality of energy using equipment, in a case the main energy is not supplied and the emergency energy is supplied as a result of the determination.

Preferably, the energy management method further comprises: controllably supplying, by the energy supply controller, the main energy to all the plurality of energy using equipment, in a case it is determined that the main energy is supplied.

Preferably, the step of controllably supplying the emergency energy to the plurality of energy using equipment includes supplying the emergency energy only to the preset relevant energy using equipment by determining preset energy using equipment among the plurality of energy using equipment.

The energy management apparatus and an energy management method, and the energy management system including an energy management apparatus according to the present disclosure are advantageous in that an energy supplied by a charged energy of a battery in an electric vehicle is used as an emergency energy and supplied to an energy using equipment, in case a main energy is not supplied from outside, whereby the energy using equipment can be supplied with the energy for operation even if an energy generation system is not installed, in a case the main energy is not supplied.

The energy management apparatus and an energy management method, and the energy management system including an energy management apparatus according to the present disclosure are also advantageous in that an energy supplied by a new renewable energy generation system such as a solar energy generation system, a wind power energy generation system or a fuel cell system can be used as an emergency energy, in case a main energy is not supplied from outside, in a case the new renewable energy generation system such as the solar energy generation system, the wind power energy generation system or the fuel cell system is installed.

The energy management apparatus and an energy management method, and the energy management system including an energy management apparatus according to the present disclosure are further advantageous in that an energy is supplied only to a predetermined energy using equipment, whereby a limited amount of emergency energy can be effectively utilized.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a schematic block diagram illustrating an energy management system according to an exemplary embodiment of the present disclosure;

FIG. 2 is a schematic block diagram illustrating an energy management system according to another exemplary embodiment of the present disclosure;

FIG. 3 is a schematic block diagram illustrating an energy management system according to still another exemplary embodiment of the present disclosure; and

FIG. 4 is a schematic flow chart illustrating an energy management method according to an exemplary embodiment of the present disclosure.

### DETAILED DESCRIPTION

The terms “power” and “energy” may be used interchangeably herein. It is to be understood that “power” generally refers to a rate at which work is performed (e.g., measured in watts or comparable units), while “energy” generally refers to a capacity for doing work (e.g., measured in kilowatt-hours (kWh), joules or comparable units). However, the term “power” may be used herein to refer to both. For example, the term “power” as used herein may refer to a rate of transfer, use, or generation of electrical energy as well as electrical energy itself. It should also be noted that as used herein, the term “bill” may be used to refer to the more general term “cost.” Furthermore, the term “bill” may refer to a bill balance (where a billing cycle for the bill is not yet completed, for example).

As used herein, an energy user and an energy consumer may be interchangeably used.

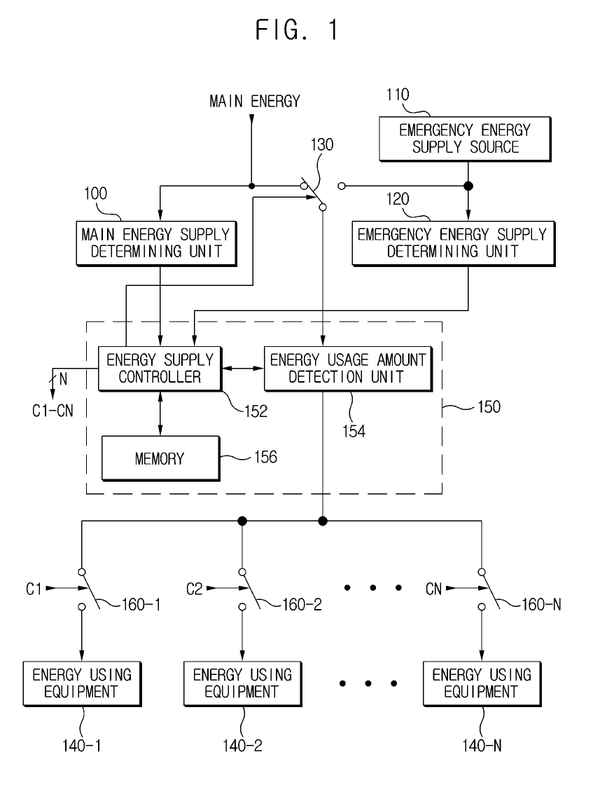

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

As used herein, the terms “a” and “an” herein do not denote a limitation of quantity, but rather denote the presence of at least one of the referenced item. That is, as used herein, the singular forms “a”, “an” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Also, “exemplary” is merely meant to mean an example, rather than the best. If is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. In the drawings, the size and relative sizes of layers, regions and/or other elements may be exaggerated or reduced for clarity. Descriptions of well-known components and processing techniques may be omitted so as not to unnecessarily obscure the embodiments of the disclosure.

Now, an energy management apparatus, an energy management method and an energy management system including an energy management apparatus according to an exemplary embodiment of the present disclosure will be described in detail with reference to the accompanying drawings.

FIG. 1 is a schematic block diagram illustrating an energy management system according to an exemplary embodiment of the present disclosure, where reference numeral 100 is a main energy supply determining unit. The main energy supply determining unit (100) determines whether a main energy is supplied from outside. In a non-limiting example, the main energy may be a commercial AC power supplied by a power company, and the main energy supply determining unit (100) determines whether the commercial AC power is supplied from outside.

Reference numeral 110 is an emergency energy supply source, and converts an energy charged in a battery of an electric vehicle to a commercial energy such as a commercial AC power, and supplies the converted commercial energy as an emergency energy, for example. The emergency energy supply source (110) is a new renewable energy generation system such as a solar energy generation system, a wind power energy generation system or a fuel cell system and generates energy by using the solar power, the wind power and the fuel cell, where the generated energy is supplied as an emergency energy.

Reference numeral 120 is an emergency energy supply determining unit. The emergency energy supply determining unit (120) determines whether the emergency energy supply source (110) has supplied the emergency energy, and determines an amount of emergency energy, where the emergency energy supply determining unit (120) preferably determines that the emergency energy has not been supplied, in a case the emergency energy supplied by the emergency energy supply source (110) is less than a preset amount of energy.

Reference numeral 130 is an energy selection switch. The energy selection switch (130) is switched by an energy selection control signal to select an emergency energy supplied by the main energy or the emergency energy supply source (110).

Reference numerals 140-1˜140-n are a plurality of energy using equipment. The plurality of energy using equipment (140-1˜140-n) is operated by using the energy selected by the energy selection switch (130). In a non-limiting example, The plurality of energy using equipment (140-1˜140-n) is an electric load such as an illumination device, a refrigerator or a washing machine, and is operated by the energy selected by the energy selection switch (130).

Reference numeral 150 is a smart meter. The smart meter (150) generates the energy selection control signal in response to a determination signal of the emergency energy supply determining unit (120) to control the switching operation of the energy selection switch (130). Furthermore, the smart meter (150) supplies the energy selected by the energy selection switch (130) to the plurality of energy using equipment (140-1˜140-n) and detects an amount of energy used by the plurality of energy using equipment (140-1˜140-n).

The smart meter (150) selectively generates energy supply control signals (C1˜Cn) to allow the emergency energy to be supplied only to the preset selective plurality of energy using equipment (140-1˜140-n), in a case the main energy is not supplied to cause the energy selection switch (130) to selectively control the emergency energy supplied by the emergency energy supply source (110). The smart meter (150) includes an energy supply controller (152), an energy usage detection unit (154) and a memory (156).

The energy supply controller (152) generates the energy selection control signal in response to determination signals from the main energy supply determining unit (100) and the emergency energy supply determining unit (120) and controls the switching operation of the energy selection switch (130).

The energy usage detection unit (154) detects the amount of energy used by the plurality of energy using equipment (140-1˜140-n) and provides the amount of energy to the energy supply controller (152). The memory (156) is pre-stored with lists of the plurality of energy using equipment (140-1˜140-n) receiving the emergency energy, in a case the main energy is not supplied to cause the energy selection switch (130) to select the emergency energy of the emergency energy supply source (110).

Reference numerals 160-1˜160-n define a plurality of energy supply switches. The plurality of energy supply switches (160-1˜160-n) is switched by the energy supply control signals (C1˜Cn) generated by the energy supply controller (152) of the smart meter (150) to allow the energy outputted by the smart meter (150) to be supplied to the plurality of energy using equipment (140-1˜140-n).

In the exemplary embodiment of the energy management system thus configured according to the present disclosure, the main energy supply determining unit (100) generates a determination signal determining whether the main energy is supplied, in a case the main energy is supplied from the outside, where the generated determination signal of the main energy supply determining unit (100) is inputted to the energy supply controller (152) of the smart meter (150).

Successively, the emergency energy supply determining unit (120) determines whether the main energy is supplied using the determination signal of the main energy supply determining unit (100) and generates an energy selection control signal, whereby the energy selection switch (130) selects the main energy in response to the generated energy selection control signal.

Furthermore, the energy supply controller (152) of the smart meter (150) generates the energy supply control signals (C1˜Cn) to allow the energy usage detection unit (154) to be all connected, if it is determined by the determination signal of the main energy supply determining unit (100) that the main energy has been supplied.

Then, the main energy selected by the energy selection switch (130) is supplied to the plurality of energy using equipment (140-1˜140-n) through the energy usage detection unit (154) of the smart meter (150) and the plurality of energy supply switches (160-1˜160-n).

Under this circumstance, if the main energy is not supplied due to blackout or the like, the main energy supply determining unit (100) determines that the main energy is not supplied and outputs the determination signal to the energy supply controller (152) of the smart meter (150).

If the main energy supply determining unit (100) determines that the main energy is not supplied and outputs the determination signal determining that the main energy is not supplied, the energy supply controller (152) of the smart meter (150) determines whether the emergency energy is supplied by receiving from the emergency energy supply source (110), by the emergency energy supply determining unit (120), the determination signal determining whether the emergency energy is supplied.

As a result of the determination, if it is determined that the main energy is not supplied and instead the emergency energy is supplied, the energy supply controller (152) of the smart meter (150) determines the plurality of energy using equipment (140-1˜140-n) stored in the memory (150) and to be supplied with the emergency energy.

In a non-limiting example, the memory (150) is pre-stored with a list of the plurality of energy using equipment (140-1˜140-n) such as illumination devices that must be operated continuously by being supplied with the emergency energy if the main energy is not supplied, where the energy supply controller (152) determines the plurality of energy using equipment (140-1˜140-n) pre-stored in the memory (150) for being supplied with the emergency energy.

If the emergency energy-receivable plurality of energy using equipment (140-1˜140-n) is determined, the energy supply controller (152) selectively generates the energy supply control signals (C1˜Cn) for controlling connection of the plurality of energy using equipment (140-1˜140-n) connected to the relevant plurality of energy using equipment (140-1˜140-n).

Thereafter, the energy supply controller (152) generates the energy selection control signal to cause the energy selection switch (130) to selectively control the emergency energy supplied by the emergency energy supply source (110), whereby the emergency energy supplied by the emergency energy supply source (110)is selected by the energy selection switch (130), and the selected emergency energy is supplied to the relevant plurality of energy using equipment (140-1˜140-n) through the energy usage detection unit (154) of the smart meter (150) and the plurality of selectively connected energy supply switches (160-1˜160-n).

Under this circumstance, if the emergency energy supplied by the emergency energy supply source (110) is discharged to become less than a preset amount of energy, the emergency energy supply determining unit (120) generates a determination signal notifying that there is no emergency energy, and the energy supply controller (152) opens all the plurality of energy supply switches (160-1˜160-n) in response to the determination signal generated by the emergency energy supply determining unit (120). As a result, there is no more discharge of energy from the emergency energy supply source (110) to prevent damage caused by the over-discharge.

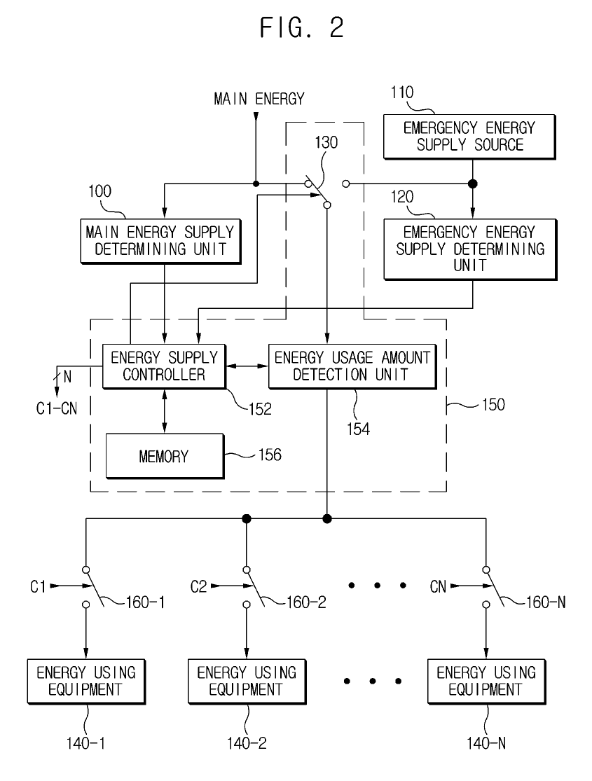

FIG. 2 is a schematic block diagram illustrating an energy management system according to another exemplary embodiment of the present disclosure.

Referring to FIG. 2, the energy management system according to another exemplary embodiment of the present disclosure includes the energy selection switch (130) integrally formed inside the smart meter (150).

In the energy management system according to another exemplary embodiment of the present disclosure, the switching operation of the energy selection switch (130) can be simply controlled using the energy selection control signal generated by the energy supply controller (152) of the smart meter (150), dispensing with a separate interface means (not shown), by integrally forming the energy selection switch (130) inside the smart meter (150).

That is, interface means for switching the energy selection switch (130) using the energy selection control signal generated by the energy supply controller (152) of the smart meter (150), in a case the energy supply controller (152) of the smart meter (150) generates the energy selection control signal, and the switching operation is controlled by applying the generated energy selection control signal to the energy selection switch (130).

However, the switching operation of the energy selection switch (130) can be simply controlled by integral formation of the energy selection switch (130) inside the smart meter (150), free from the separate interface means, in the energy management system according to another exemplary embodiment of the present disclosure.

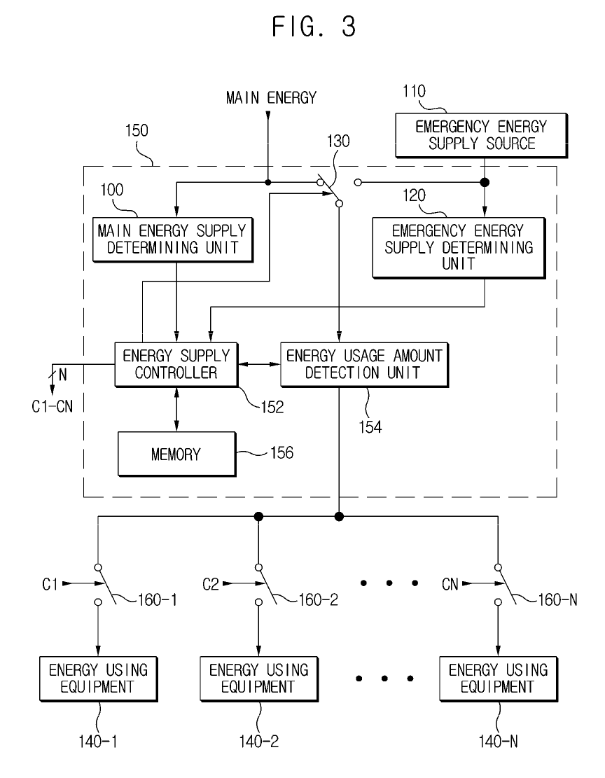

FIG. 3 is a schematic block diagram illustrating an energy management system according to still another exemplary embodiment of the present disclosure.

Referring to FIG. 3, the energy management system according to still another exemplary embodiment of the present disclosure integrally includes the energy selection switch (130), the main energy supply determining unit (100), and the emergency energy supply determining unit (120) inside the smart meter (150).

In the energy management system according to still another exemplary embodiment of the present disclosure, there is no need of separately mounting interface means (not shown) for inputting, by the energy supply controller (152) of the smart meter (150), the determination signals generated by the main energy supply determining unit (100), and the emergency energy supply determining unit (120), by integrally forming the energy selection switch (130), the main energy supply determining unit (100), and the emergency energy supply determining unit (120) inside the smart meter (150).

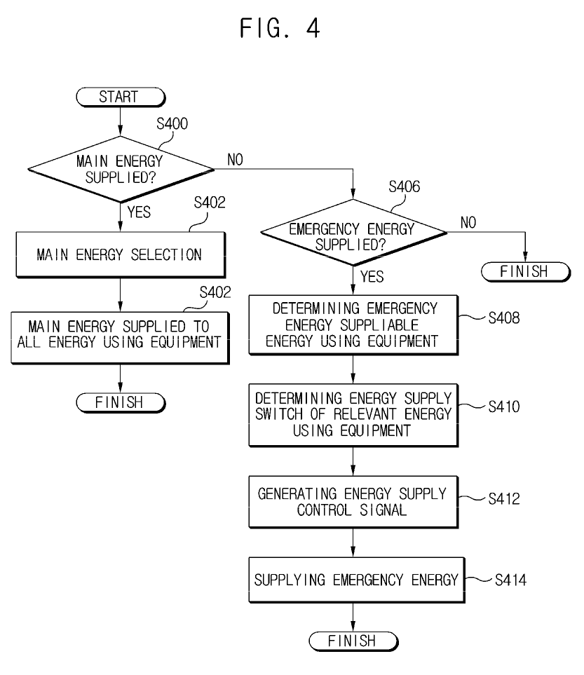

FIG. 4 is a schematic flow chart illustrating an energy management method according to an exemplary embodiment of the present disclosure.

Referring to FIG. 4, the energy supply controller (152) of the smart meter (150) determines whether the main energy is supplied using the determination signal of the main energy supply determining unit (100) (S400).

As a result of the determination, if it is determined that the main energy is normally supplied, the energy supply controller (152) of the smart meter (150) generates an energy selection control signal to cause the energy selection switch (130) to controllably select the main energy (S402). Then, the energy supply controller (152) of the smart meter (150) generates the energy supply control signals (C1˜Cn) to allow all the plurality of energy supply switches (160-1˜160-n) to be connected.

Successively, the main energy selected by the energy selection switch (130) is supplied to the plurality of energy using equipment (140-1˜140-n) via the energy usage detection unit (154) of the smart meter (150) and the plurality of energy supply switches (160-1˜160-n), whereby the plurality of energy using equipment (140-1˜140-n) can be normally operated (S404).

As a result of the determination, if it is determined that the main energy is not normally supplied, the energy supply controller (152) of the smart meter (150) inputs the determination signal of the emergency energy supply determining unit (120) to determine whether the emergency energy is supplied from the emergency energy supply source (110) (S406).

As a result of the determination, if it is determined that the main energy is not normally supplied, the energy supply controller (152) of the smart meter (150) terminates control of energy supply.

As a result of the determination, if it is determined that the main energy is normally supplied, the energy supply controller (152) of the smart meter (150) determines the plurality of emergency energy-receivable energy using equipment (140-1˜140-n) using the memory (156) (S408), and determines the plurality of relevant energy supply switches (160-1˜160-n) of the plurality of energy using equipment (140-1˜140-n) to be supplied with the emergency energy (S410).

If the plurality of relevant energy supply switches (160-1˜160-n) of the plurality of energy using equipment (140-1˜140-n) to be supplied with the emergency energy (S410) is determined, the energy supply controller (152) of the smart meter (150) selectively generates the energy supply control signals (C1˜Cn) of the plurality of relevant energy supply switches (160-1˜160-n) (S412), whereby the plurality of relevant energy supply switches (160-1˜160-n) are selectively connected in response to the selectively generated energy supply control signals (C1˜Cn).

Furthermore, the energy supply controller (152) of the smart meter (150) generates the energy selection control signal, and the energy selection switch (130) selects the emergency energy generated by the emergency energy supply source (110) in response to the generated energy selection control signal, whereby the emergency energy is supplied to the plurality of relevant energy using equipment (140-1˜140-n) (S414).

The energy management apparatus and an energy management method, and the energy management system including an energy management apparatus according to the present disclosure have industrial applicability in that an energy supplied by a charged energy of a battery in an electric vehicle is used as an emergency energy and supplied to an energy using equipment, in case a main energy is not supplied from outside, whereby the energy using equipment can be supplied with the energy for operation even if an energy generation system is not installed, in a case the main energy is not supplied.

The energy management apparatus and an energy management method, and the energy management system including an energy management apparatus according to the present disclosure have another industrial applicability in that an energy supplied by a new renewable energy generation system such as a solar energy generation system, a wind power energy generation system or a fuel cell system can be used as an emergency energy, in case a main energy is not supplied from outside, in a case the new renewable energy generation system such as the solar energy generation system, the wind power energy generation system or the fuel cell system is installed.

The energy management apparatus and an energy management method, and the energy management system including an energy management apparatus according to the present disclosure have still another industrial applicability in that an energy is supplied only to a predetermined energy using equipment, whereby a limited amount of emergency energy can be effectively utilized.

Although the present disclosure has been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An energy management apparatus, the apparatus comprising: a main energy supply determining unit determining whether main energy is supplied from a main energy supply unit; and an emergency energy supply determining unit determining whether emergency energy is supplied from an emergency energy supply source, and a smart meter supplying the main energy to the plurality of energy using equipment, in a case the main energy supply determining unit determining that energy is supplied from the main energy supply unit, and selecting the emergency energy to supply the emergency energy to the plurality of energy using equipment, in a case the main energy supply determining unit determines that the main energy is not supplied from the main energy supply unit, and that the emergency energy supply determining unit determines that the emergency energy is supplied from the emergency energy supply source.

2. The apparatus of claim 1, further comprising an energy selection switch for switching the main energy and emergency energy to select one of the main energy and emergency energy, wherein the smart meter allows the energy selection switch to select the main energy and to controllably supply the main energy to the plurality of energy using equipment, in a case the main energy supply determining unit determines that the main energy is supplied, and the smart meter allows the energy selection switch to select the emergency energy and to controllably supply the emergency energy to the plurality of energy using equipment, in a case the main energy supply determining unit determines that the main energy is not supplied and the emergency energy supply determining unit determines that the emergency energy is being supplied.

3. The apparatus of claim 1, wherein the emergency energy supply source supplies a charged energy of a battery mounted at an electric vehicle by converting the charged energy to a commercial energy.

4. The apparatus of claim 1, wherein the emergency energy supply source includes energy generated by a solar energy generation system, a wind power generation system, or a fuel cell system.

5. The apparatus of claim 1, wherein the emergency energy supply determining unit determines that the emergency energy has not been supplied if the emergency energy supplied by the emergency energy supply source is less than a preset amount of energy.

6. The apparatus of claim 2, wherein the smart meter includes an energy supply controller allowing the energy selection switch to controllably select the main energy, in a case the main energy supply determining unit determines that main energy is supplied from the main energy supply unit, and allowing the energy selection switch to controllably select the emergency energy, in a case the main energy supply determining unit determines that the main energy is not supplied from the main energy supply unit, and that the emergency energy supply determining unit determines that the emergency energy is supplied from the emergency energy supply source; and an energy usage amount detecting unit supplying the energy selected by the selection switch to the plurality of energy using equipment in response to control of the energy supply controller and detecting an energy usage amount.

7. The apparatus of claim 6, wherein the energy supply controller controls in such a manner that the energy selection switch controllably supplies the emergency energy only to the preset plurality of energy using equipment among the plurality of energy using equipment, in a case the energy selection switch controllably selects the emergency energy.

8. The apparatus of claim 7, wherein the pre-set energy using equipment includes an illumination load.

9. The apparatus of claim 7, wherein the smart meter further includes a memory for storing lists of the preset energy using equipment.

10. An energy management system including an energy management apparatus, the system comprising: a plurality of energy using equipment; a plurality of energy supply switches supplying energy to each of the plurality of energy using equipment; and an energy management apparatus selecting one energy by determining whether main energy and emergency energy are supplied, and supplying one of the selected energies to the plurality of energy using equipment through the plurality of energy supply switches.

11. The system of claim 10, wherein the energy management apparatus includes: a main energy supply determining unit determining whether main energy is supplied; an emergency energy supply determining unit determining whether emergency energy is supplied from an emergency energy supply unit; an energy selection switch switching the main energy and the emergency energy and selecting one of the main energy and the emergency energy; and a smart meter allowing the energy selection switch to select the main energy and the main energy to be controllably supplied to the plurality of energy using equipment in a case the main energy supply determining unit determines that the main energy is supplied, and allowing the emergency energy selection switch to select the emergency energy and the emergency energy to be controllably supplied to the plurality of energy using equipment in a case the main energy supply determining unit determines that the energy is not supplied, and that the emergency energy supply determining unit determines that the emergency energy is supplied.

12. The system of claim 10, wherein the energy management apparatus includes: a main energy supply determining unit determining whether main energy is supplied from a main energy supply unit; and an emergency energy supply determining unit determining whether emergency energy is supplied from an emergency energy supply source, and a smart meter supplying the main energy to the plurality of energy using equipment, in a case the main energy supply determining unit determining that energy is supplied from the main energy supply unit, and selecting the emergency energy to supply the emergency energy to the plurality of energy using equipment, in a case the main energy supply determining unit determines that the main energy is not supplied from the main energy supply unit, and that the emergency energy supply determining unit determines that the emergency energy is supplied from the emergency energy supply source.

13. The system of claim 11, wherein the emergency energy supply source supplies a charged energy of a battery mounted at an electric vehicle by converting the charged energy to a commercial energy.

14. The system of claim 11, wherein the emergency energy supply source includes energy generated by a solar energy generation system, a wind power generation system, or a fuel cell system.

15. The system of claim 11, wherein the emergency energy supply determining unit determines that the emergency energy has not been supplied if the emergency energy supplied by the emergency energy supply source is less than a preset amount of energy.

16. The system of claim 11, wherein the smart meter includes an energy supply controller allowing the energy selection switch to controllably select the main energy, in a case the main energy supply determining unit determines that main energy is supplied from the main energy supply unit, and allowing the energy selection switch to controllably select the emergency energy, in a case the main energy supply determining unit determines that the main energy is not supplied from the main energy supply unit, and that the emergency energy supply determining unit determines that the emergency energy is supplied from the emergency energy supply source; and an energy usage amount detecting unit supplying the energy selected by the selection switch to the plurality of energy using equipment in response to control of the energy supply controller and detecting an energy usage amount.

17. The system of claim 12, wherein the smart meter includes: an energy selection switch selecting the main energy or the emergency energy; an energy supply controller allowing the energy selection switch to controllably select the main energy, in a case the main energy supply determining unit determines that main energy is supplied from the main energy supply unit, and allowing the energy selection switch to controllably select the emergency energy, in a case the main energy supply determining unit determines that the main energy is not supplied from the main energy supply unit, and that the emergency energy supply determining unit determines that the emergency energy is supplied from the emergency energy supply source; and an energy usage amount detecting unit supplying the energy selected by the selection switch to the plurality of energy using equipment in response to control of the energy supply controller and detecting an energy usage amount.

18. An energy management method, the method comprising: determining, by a main energy supply determining unit, whether main energy is supplied; determining, by an emergency energy supply determining unit, whether emergency energy is supplied; and controllably supplying, by an energy supply controller, the emergency energy to a plurality of energy using equipment, in a case the main energy is not supplied and the emergency energy is supplied as a result of the determination.

19. The method of claim 18, further comprising: controllably supplying, by the energy supply controller, the main energy to all the plurality of energy using equipment, in a case it is determined that the main energy is supplied.

20. The method of claim 18, wherein the step of controllably supplying the emergency energy to the plurality of energy using equipment includes supplying the emergency energy only to the preset relevant energy using equipment by determining preset energy using equipment among the plurality of energy using equipment.
